(19) United States
(12) Patent Application Publication
(10) Pub. No.: US 2006/0156996 A1
(43) Pub. Date: Jul. 20, 2006

(54) Piglet restraint

(76) Inventor: Marjollaine Henry, St. Bernard de Dorchester (CA)

Correspondence Address: ADE & COMPANY INC., P.O. BOX 28006 1795 HENDERSON HIGHWAY, WINNIPEG, MB, R2G1P0, CA

(21) Appl. No.: 11/300,578

(22) Filed: Dec. 15, 2005

Related U.S. Application Data
(60) Provisional application No. 60/636,886, filed on Dec. 20, 2004.

(30) Foreign Application Priority Data
Dec. 14, 2005 (CA) 2,530,636

(51) Int. Cl. A01K 15/04

(52) U.S. Cl. 119/751

(57) ABSTRACT

An animal restraint apparatus for use in treatment procedures particularly on piglets includes a cart having a bin for containing the piglets taken from a pen and a restraint system mounted on the cart defined by a pair of animal engagement cushions. The cushions form a generally concave shape at least when deformed and are mounted for relative movement from a first separated position in which the animal can be inserted between the concave inwardly facing surfaces and laid onto a backstop member to a second closed position in which the animal is restrained. The first and second members each have a length to extend along a significant part of the body of the animal leaving the head and rear ends exposed. A tool rack is provided on the cart for tools to carry out the procedures.

This application claims the benefit of the filing date as priority under 35 U.S.C. 119 from Provisional application Ser. No. 60/636,886 filed Dec. 20, 2004.

This invention relates to a restraint device which can be used with small animals to hold the animal for various operation procedures on the animal, and is particularly but not exclusively designed and arranged for use on piglets during castration.

### BACKGROUND OF THE INVENTION

Devices to assist in restraining a small animal such as a piglet during surgical procedures such as castration are previously known and examples are shown in U.S. Pat. No. 4,059,869 (Dunstheimer); U.S. Pat. No. 4,140,082 (Easton); and U.S. Pat. No. 3,389,691 (Poage). Easton and Poage show cradle devices in which the animal is laid on its back in a supporting cradle and is held down by straps over its torso. Dunstheimer discloses an arrangement in the form of a pair of tongs in a horizontal plane which grasp the animal in front of its hips so that it is suspended from the tongs with its head down toward the ground and its genital area presented upwardly. In Japanese Patent Application 2001-224270 (Tomoyoshi) published Aug. 21, 2001 is provided a stand with two side squeeze plates and a nose cap for holding the animal.

These arrangements are difficult to operate and support the animal in an inconvenient manner so that they are generally not used in the industry.

A requirement remains therefore for an improved restraint for small animals such as piglets during surgical procedure such as castration.

### SUMMARY OF THE INVENTION

According to one aspect of the invention there is provided an animal restraint apparatus for use in treatment procedures on the animal when restrained comprising:

a first and a second animal engagement member;

the first and second members being mounted for relative movement from a first separated position in which the animal can be inserted between inwardly facing surfaces of the first and second members to a second closed position in which the animal is restrained between the inwardly facing surfaces of the first and second members;

the first and second members each having a length to extend along a significant part of the body of the animal leaving the head exposed beyond one end and the genital region exposed beyond the other end;

the members having at least the inwardly facing surfaces formed of a resilient compressible material such that the surfaces can deform under pressure from the animal during squeezing the animal in the second closed position;

the first and second members each being arranged such that the inwardly facing surfaces define, in the second closed position, a concave surface thereon and extending therealong with the concave surfaces being aligned so as to face one another and define therebetween a generally cylindrical receptacle area in which the animal is partly enveloped and is squeezed.

The treatment procedures referred to herein can include any operation or activity carried out on an animal. These include any post natal activity on a piglet such as castration, tail docking, tooth grinding, vaccination and inspections such as for hernia.

While the apparatus is primarily designed for use in castration procedures, it can be used for other procedures on the animal such as vaccination either at the same time as the castration process or as a separate action. The procedure may be or merely may include an inspection of the animal since the arrangement of the restraint allows a more effective inspection of the stomach and groin area for any possible hernia.

Preferably the members are formed of a cushion material mounted on a rigid support.

Preferably the cushion material is formed with a concave shape such that a portion thereof extends over the animal in the closed position. The cushions are preferably formed with the concave shape since this best surrounds and confines the animal. However the cushions may be formed such that they are sufficiently compressible that the concave shape is formed by contact with the animal. For this purpose, the cushion may be formed of a softer material in the required locations to allow the compression.

Preferably the relative movement of the members is arranged in a direction generally at right angles to an axis longitudinally along the cylindrical reception area. The movement may be linear guided by suitable slides or other linear guiding members or may be provided by a pivot of one or both of the members so that the members move in an arc.

Preferably the first and second members define an opening on one side into which the animal is inserted and a back stop member on the opposite side having a contact surface against which the animal rests as at least one of the first and second members is moved in a direction generally parallel to the contact surface to the second closed position.

Preferably the back stop member is a separate item from the clamping members and the clamping members move across or over the back stop member. However in an alternative arrangement, the back stoop member may be defined by a piece of at least one of the first and second members

Preferably the back stop member is a separate element over which at least one of the first and second members can move.

The backstop member can be simply a piece of fabric which collapses as the members are moved together across the fabric, thus taking the appearance of a hammock which collapses end to end. However a flat cushion arrangement over which the members move is preferred since it better and more effectively supports the animal in a cleaner and more effective way. The formation of the device by cushions covered with an impermeable fabric allows improved hygiene.

The movement of the members can be effected by any suitable motive force including manual force from the operator actuated by a hand operated lever or a foot operated lever, or including any power source actuated by a switch such as mains electric, battery power or pneumatic. The communication of the force may be by way of any suitable linkage such as a lever linkage or by a cable.

Preferably the restraining members have a length greater than 2 inches.

Preferably the apparatus includes a cart mounted on wheels for movement from pen to pen within an animal containment area, the cart having a bin with an open top and depending walls for containing a number of the animals, the first and a second animal engagement members being mounted on the cart for receiving the animals extracted from the bin.

If mounted on a cart, the cart may have a rack and/or a standing rod for a plurality of tools to be used on the animal when restrained. The tools can be powered tools such as grinders or may be hand tools such as clippers and pliers. Where power tools are provided, the cart may include a power source for the tools or they may be powered by individual batteries.

As an alternative to the cart mount, the apparatus may be designed so that it can be mounted on a fence at the pen allowing the animals to be lifted from the pen for individual attention. Alternatively the apparatus and cart may be designed so that the same mounting can be sued for the cart or for the fence support.

A leg holding system may be provided to hold the rear legs of the animal down onto the restraint, but this is not essential as the clamping action of the animal in the cushion members assists in suitably locating the animal for inspection and the procedures. If used, the holding system can be simply a strap.

According to a second aspect of the invention there is provided an animal restraint apparatus for use in treatment procedures on the animal when restrained comprising:

a first and a second animal engagement member;

the first and second members being mounted for relative movement from a first separated position in which the animal can be inserted between inwardly facing surfaces of the first and second members to a second closed position in which the animal is restrained between the inwardly facing surfaces of the first and second members;

the first and second members each having a length to extend along a significant part of the body of the animal;

the members having at least the inwardly facing surfaces formed of a resilient compressible material such that the surfaces can deform under pressure from the animal during squeezing the animal in the second closed position;

the first and second members being arranged to define an opening on one side into which the animal is inserted;

and a back stop member on the opposite side from the opening having a contact surface against which the animal engages when inserted in the opening;

the contact surface being arranged to locate the animal while at least one of the first and second members is moved in a direction generally across the contact surface to the second closed position.

According to a third aspect of the invention there is provided an animal restraint apparatus for use in treatment procedures on the animal when restrained comprising:

a cart mounted on wheels for movement from pen to pen within an animal containment area;

the cart having a bin with an open top and depending walls for containing a number of the animals,

a first and a second animal engagement member mounted for relative movement from a first separated position in which the animal can be inserted between inwardly facing surfaces of the first and second members to a second closed position in which the animal is restrained between the inwardly facing surfaces of the first and second members;

the first and a second animal engagement members being mounted on the cart for receiving the animals extracted from the bin.

Preferably the cart has a rack and/or a standing rod for a plurality of tools to be used on the animal when restrained.

Preferably the cart has electrical power outlet for supplying power to one or more of the plurality of tools to be used on the animal when restrained.

### BRIEF DESCRIPTION OF THE DRAWINGS

One embodiment of the invention will now be described in conjunction with the accompanying drawings in which:

FIG. 1 is a front elevational view of a restraining apparatus according to the present invention wherein the embodiment is arranged for mounting on the wall of a pen, the restraining members being shown in the initial open position with the animal laid into the enclosure for restraint.

FIG. 2 is the same view as FIG. 1 showing the restraining members in the closed position restraining the animal.

FIG. 3 is a top plan view of the apparatus of FIGS. 1 and 2.

FIG. 4 is a front elevational view of a second embodiment in which the restraint device is mounted on a cart.

FIG. 5 is a side elevational view of the cart of FIG. 4 in which a modified construction of the restraining apparatus is mounted.

FIG. 6 is an isometric view of the cart of FIG. 5.

FIG. 7 is an isometric view of the restraint components only of FIG. 5 for mounting on the cart.

In the drawings like characters of reference indicate corresponding parts in the different figures.

### DETAILED DESCRIPTION

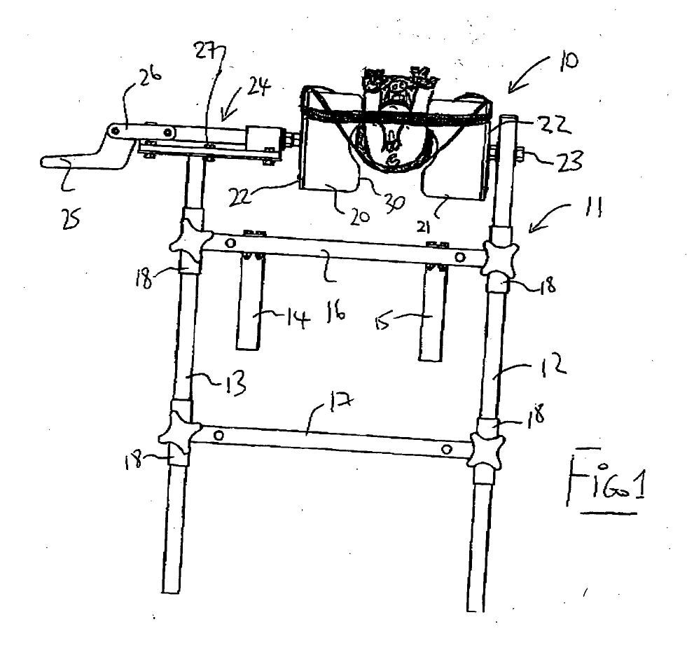

The restraint apparatus generally indicated at 10 is mounted on a frame 11. In the embodiment of FIG. 1 the frame 11 is arranged to be mounted over the top rail of a wall of a pen so that two legs 12 and 13 depend downwardly on the outside of the wall and two hook elements 14 and 15 engage over the wall so that a top of the wall is trapped between the legs 12 and 13 and the hook elements 14 and 15 with the hook elements depending along the rear side of the wall. The legs are connected by cross members 16 and 17 which can be adjusted on adjustable slides 18.

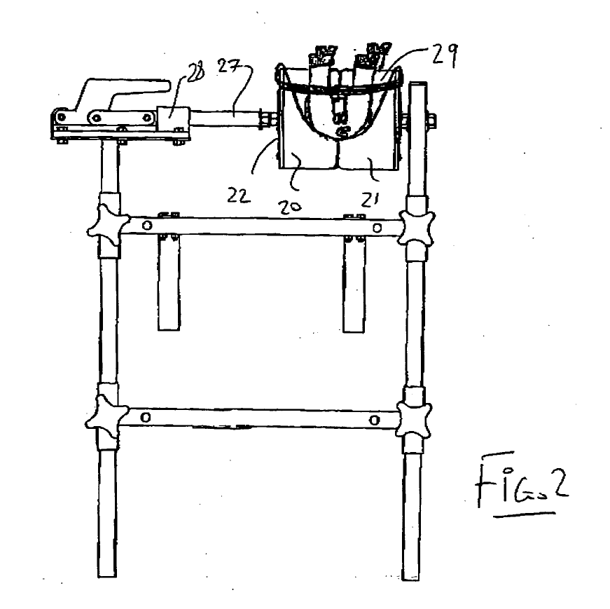

The restraint device comprises a pair of members 20 and 21. The members 20 and 21 each include a backing plate 22 which is rigid and supports the members with the two backing plates 22 parallel and spaced. One of the backing plates is fixed to the side rail 12 by a supporting connection 23. The other of the backing plates 22 is carried on a manually operable press device 24 with a handle 25 operating a lever 26 which moves a slide 27 in a guide 28 so that the slide moves linearly through the guide 28 by movement of the handle 25 through 1800 as will be apparent from comparing FIGS. 1 and 2 so that the slide 27 moves the backing plate 22 of the member 20 between the open position shown in FIG. 1 where the members 20 and 21 are spaced to the closed position shown in FIG. 2 wherein the members are squeezed together.

The restraining members 20 and 21 each further comprise a cushion 29 which has a rear wall attached to the respective backing plate 22 and extends from the backing plate toward the other of the members to define a front surface 30 which butts that of the other restraint member in the closed position. Each of the surfaces 30 has a length L which is sufficient to engage along a majority of the length of the animal of the body leaving the head exposed beyond a front edge 32 and a genital and rear area of the animal exposed beyond a rear edge 33. The length L is thus greater than two inches and is preferably of the order of 4 to 6 inches so that pressure from the restraint member through the surface 30 onto the animal provides a squeezing action along a length of the animal so that the animal can be gently squeezed but without applying significant forces at any particular location.

The cushion members 29 are formed from a resilient foam with a covering layer of a suitable skin or fabric material so that the skin or fabric material providing the surface is hygienic and washable so that it can be used repeatedly for many animals over many different sessions of operation.

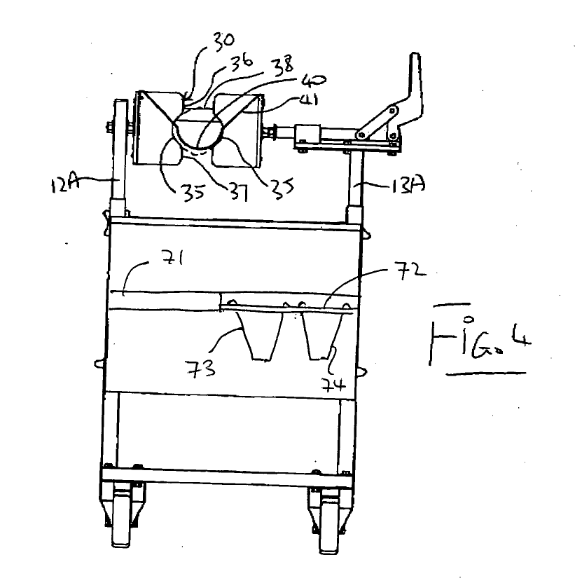

The surface 30 as best seen in FIG. 4 where the animal is omitted includes a part cylindrical recess 35 between an upper nose 36 and a lower nose 37. Thus when brought together in the position shown in FIG. 4 the part cylindrical recesses 35 define a generally cylindrical area 38 which will surround the generally cylindrical torso of the animal. At least the top between the noses 36 is open to allow some access to the upper part of the animal since it is not necessary to fully enclose the animal. In the embodiment shown also the bottom area is also open since the noses 36 and 37 are symmetrical above and below the recess 35.

Thus the generally cylindrical area 38 is arranged with the access thereof horizontal so that the animal is lying on its back in the restrained position. However this angle may change from horizontal through to an inclined angle or even to a vertical position if the operator so prefers. However the horizontal position is much preferred because this leaves the animal with its genital area presented horizontally and rearwardly so that pressure tends to squeeze the genital area rearwardly. It has been established that having the animals horizontal in this way presents the scrotum at the rear of the animal without the testicles or scrotum slipping forwardly, which would be the case if the animal were suspended vertically. Thus the scrotum and the testicles are presented at the rear and the incision can be made at the rear well away from the connection of the scrotum to the penis. In this way the incision can be made at the loose area of the scrotum without any danger of the incision extending to an area where the scrotum connects to the penis which could allow damage to be caused and infection to generate.

The resilient cushion members defining the restraint surface 30 can thus slightly compress when the members are brought together around the animal so that the animal is compressed but also the resilient members compress to provide an effective clamping action over significant part of the body of the animal to hold it well restrained against struggling without excessive pressure in any particular location which could cause damage. It will be appreciated that the size of the animals may vary so that this resilience allows the difference in size to be taken up by differences in the amount of compression of the members.

Suitable adjustment can be provided for animals of a larger size when the device is to be used with a batch of animals at a greater age and therefore larger. Thus the device is adjustable to accommodate the different size of animal with which the device may be used, bearing in mind that different procedures are contemplated which may be carried out at different ages. However there is no necessity for adjustment when used for different animals at the same age since any differences in size are relatively small and can be accommodated by the resilience of the restraining members.

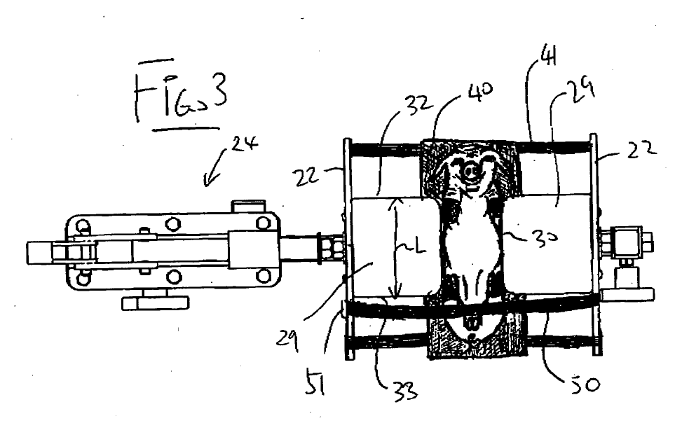

In order to allow the animal to be quickly placed into the position so that its torso is located in the area 38, there may be provided a back stop device against which the back of the animal is placed before the members are brought together. In the arrangement shown this backstop device comprises a fabric sheet 40 which defines in effect a hammock onto which the animal can be quickly placed by the operator carrying the animal by its rear legs. Thus the animal is draped on its back onto the hammock 40 so that its torso is held in position at the required location within the area 38 so that the restraining devices can be quickly closed squeezing the torso of the animal. The sheet defining the hammock 40 is carried on straps 41 which extend from the hammock to the top edge of the backing plates 22. It will be noted from FIG. 3 that the backing plates 22 extend beyond the length of the members 29 so that the straps can be located in front and behind the members 29 with the hammock having a greater length than the members 29 for quickly locating the animal in the required position on the hammock. The fabric sheet forming the hammock is of course compressible so that it simply squeezes together with the animal and wraps around the animal as the members 29 are closed.

The back stop arrangement defined by the hammock 40 may be omitted for simplicity of construction. Alternatively the hammock 40 may be replaced by a portion of one or both of the members 29. Thus the members 29 may be shaped so that the nose 37 underneath the area 38 projects out to provide a closure under the area 38 so that the animal can simply be placed onto the projecting nose of the resilient member underneath the area 38 and then the members brought together so that the recess 35 takes up the position defining the cylindrical area 38. In an alternative arrangement not shown, the animal also may be draped onto a sheet which extends from one member across toward the other and then slides into a slot on the other member

As best shown in FIG. 3 an optional strap 50 is connected from one backing plate 22 across the top of the members 29 to the top of the other sheet 22. The strap 50 is attached on one side and includes a fastening arrangement 51 on the other side so that it can be strapped down tight over the legs of the animal as best shown in FIG. 2 to pull the legs of the animal forwardly over the animals stomach thus better exposing the genital area for the operation. The strap as shown in FIG. 3 is located at the edge 33 of the members 29 so that it engages over the torso of the animal immediately at the edge 33 to hold the legs forwardly. The strap may be omitted if the operator prefers to manage the animals legs manually during the operation. Other leg hold down devices can also be used.

In FIG. 4 the same clamping arrangement for restraining the animal is mounted on legs 12A and 13A which are carried, instead of on the wall of the pen, on a wheeled cart generally indicated at 60. The device can also be purchased as device for attachment to en existing cart or dolly already available to the user. The cart 60 includes a base 61 carried on ground wheels 62 with handles 63 at a suitable location on the cart so that the cart can be moved from place to place by pushing by the user at a position adjacent the restraining device 10. On the front of the legs 12A and 13A is mounted a bin 64 with an open top 65 so that the piglets can be grasped from a farrowing pen and inserted in the bin for temporary location until each has been operated upon and returned to the pen.

Thus the device of FIG. 1 can be used by the operator simply reaching into the pen and grasping each animal in turn. The arrangement of FIG. 4 is used by the user firstly catching all of the animals and placing them in the bin and returning them to the pen after each is completed.

Other mounting arrangements for the restraining device 10 can be provided including a swivel underneath the frame structure so that the arrangement can be changed in orientation both around a vertical axis and around a horizontal axis as required by the user for best convenience of the user.

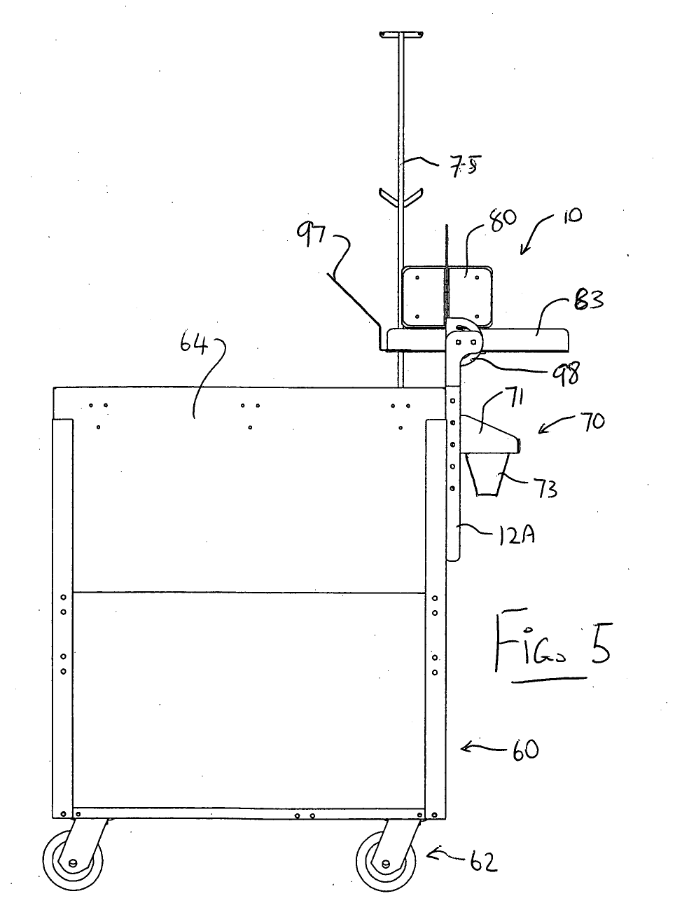

In FIGS. 4 and 5 is also shown a tool rack generally indicated at 70 which comprises a tray 71 for receiving tools laid in the tray so that the tray forms a horizontal surface together with upstanding side walls which contain and locate the tools when in the tray. Such tools may include power tools such as grinders and may include hand tools such as clippers and pliers. Alongside the tray 71 is provided is a horizontal support panel 72 for a series of depending replaceable containers 73 and 74, which may be formed of plastics material, stainless steel or any other suitable material. These containers include a top portion which sits in a hole in the horizontal panel 72 with a containing portion depending underneath the horizontal panel. These containers can be used for tools or for materials removed from the animal during the procedures. An upstanding post 75 can also be provided for hanging other items primarily vaccine bottles and syringes for use in vaccination procedures.

The rack 70 can be formed as part of a support for the restraining device 10 which can be attached onto a separate trolley or cart 60. Thus the frame which carries the restraining device and the rack can be a separate element from the trolley and can be moved from the trolley for mounting on a fence. The mounting arrangements necessary for this attachment will vary in accordance with requirements and be well known to one skilled in the art.

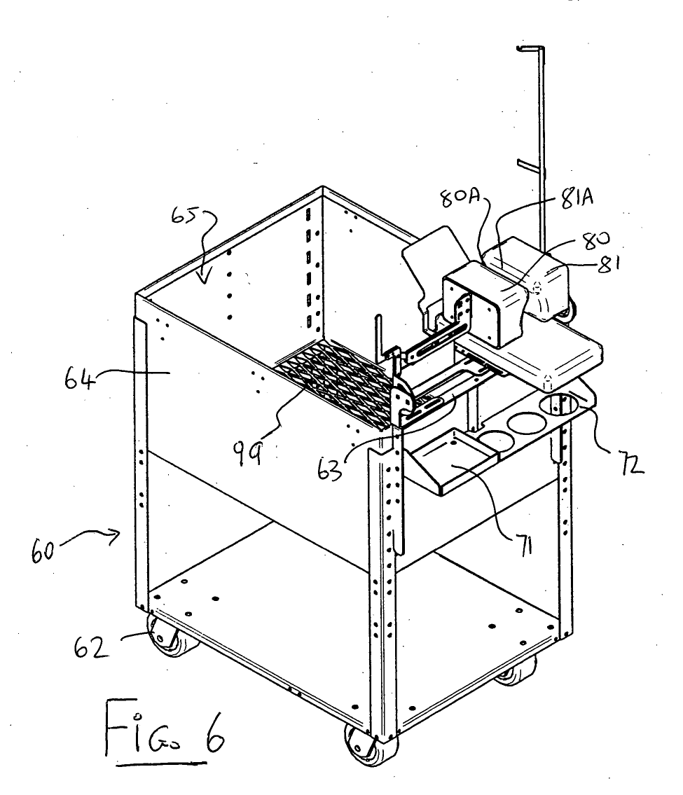

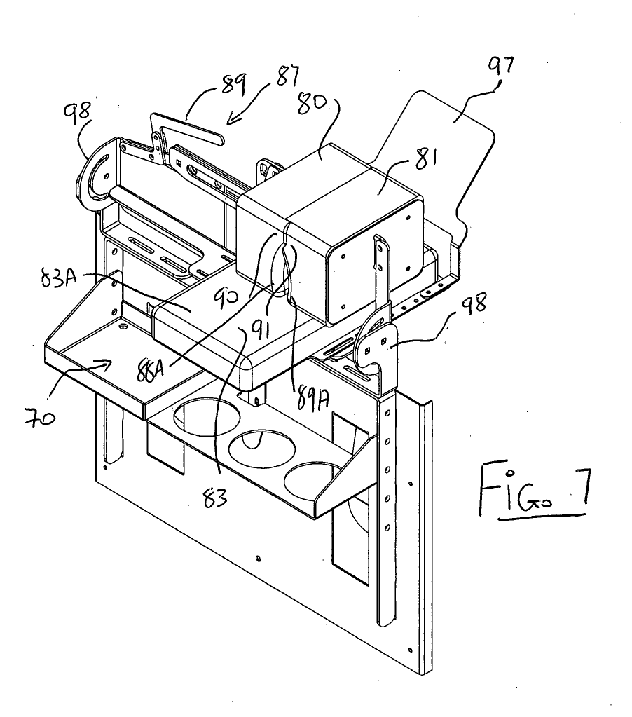

Turning now to the construction of restraining device shown in FIGS. 5, 6 and 7, a modified arrangement is provided which includes two clamping elements 80 and 81 together with a backstop member 82. The backstop member is basically horizontal and forms an upper surface 83 onto which the animal 84 can be laid. Each of the elements 80, 81 and 82 is formed from a back plate 85 together with a cushion 86. The cushion is formed from a suitable resilient material together with a covering fabric which is impervious to moisture so as to be readily cleanable and so as to be resistant to any liquids which may be present. An inclined ramp surface 97 is provided at one end of the surface 83 to provide an inclined back rest for the head of the animal.

The elements are connected together for common change of orientation on brackets 98 which provide adjustment about a transverse horizontal axis but in the preferred arrangement the backstop member 82 is horizontal and thus defines a horizontal top surface 83 onto which the back of the animal can be laid. Adjustment about an axis transverse to the axis of the bracket 98 can be provided for adjustment of the orientation of the clamping device in all directions. The squeezing members 80 and 81 are movable across the top surface 83 by drive mechanisms which are schematically indicated at 87 since of course these can vary in accordance with requirements. As in the previous embodiment the movement can be effected by a hand crank 89 which operates on one or both of the members. Other drive mechanisms including electric power and pneumatic power can also be used. The members 80 and 81 define a forwardly facing surface 80A, 81A which is generally concave so as to define a nose portion 90, 91 which extends over the stomach of the animal when laid on the surface 83. Thus the curved or concave surfaces receive the stomach area of the animal and the nose engages over the stomach area to hold the animal down onto the surface 83. As the animal is laid on its back on the surface 83, the surfaces 88 and 89 are generally vertical at the lower 1.5 part as indicated at 88A and 89A so that they meet the surface 83 generally at a right angle. It will be appreciated that the animal is thus squeezed at its sides by the generally vertical sections 88A and 89A and the nose portions 90 and 91 extend over the stomach of the animal to hold the animal down onto the surface 83. The three surfaces thus define a generally cylindrical area, having an axial length of greater than 2 inches and sufficient to squeeze the animal without discomfort while leaving the head and rear end open for access beyond the ends of the device, which wraps around the animal and contains the animal as it is restrained on the surface 83. The bottom surface of the cushions defining the members 80 and 81 slides over the top surface 83 so that there are no pinch points for the animal. If the animal is not properly centered, the animal is merely pushed to one side of the surfaces as they move forward or as one of the surfaces moves relative to the other. The animal rests on its back on the surface 83 with its head on the ramp 97 for more comfort and the rear end of the animal rests on an extension portion 83A which extends beyond the rear end of the clamping members 80 and 81.

The height of the bin and restraining device is adjustable to accommodate different height operators. This can be carried out by any suitable mechanism but in the example shown different locating holes or slots in the bin wall can be selected.

One or more of the castors can be locking for improved stability in movement.

The bin has a wire mesh bottom wall 99 which is coated with a rubberized material for comfort and is removable for cleaning and sanitation.

The cart and the bin are designed and arranged such that the restraint can be located at either end or two separate restraint can be located at respective ends for use by two operators working simultaneously on the animals in the bin. An associated tool tray is also part of the restraint and thus can be provided at both ends for the operators.

The bin can be mounted on a scale on the cart so as to provide a weighing capability for the animals place in the bin either separately or as a collection from the whole litter.

The device can provide the following features advantages:
quick, simple and easy to use
adapts to any working technique
frees both hands for maximum precision, uniformity and quality of nursing process
works at various angles
saves labour and improve staff management
ensures efficiency and safety of process
decreases risk of carpal tunnel syndrome or other repetitive stress physical problems
optimizes piglet comfort and stabilization
decreases risk of post surgical infection, complication and mortality
tray keeps processed tools at hand
large size piglet bin to contain the pigs to be worked upon before they are returned to the pen
easy to clean up and sterilize for enhanced hygiene

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. An animal restraint apparatus for use in treatment procedures on the animal when restrained comprising:
a first and a second animal engagement member;
the first and second members being mounted for relative movement from a first separated position in which the animal can be inserted between inwardly facing surfaces of the first and second members to a second closed position in which the animal is restrained between the inwardly facing surfaces of the first and second members;
the first and second members each having a length to extend along a significant part of the body of the animal leaving the head exposed beyond one end and the genital region exposed beyond the other end;
the members having at least the inwardly facing surfaces formed of a resilient compressible material such that the surfaces can deform under pressure from the animal during squeezing the animal in the second closed position;
the first and second members each being arranged such that the inwardly facing surfaces define, in the second closed position, a concave surface thereon and extending therealong with the concave surfaces being aligned so as to face one another and define therebetween a generally cylindrical receptacle area in which the animal is partly enveloped and is squeezed.

2. The apparatus according to claim 1 wherein the members are formed of a cushion material mounted on a rigid support.

3. The apparatus according to claim 3 wherein the cushion material is pre-formed with a concave shape such that a portion thereof extends over the animal in the closed position.

4. The apparatus according to claim 1 wherein the relative movement of the members is arranged in a direction generally at right angles to an axis longitudinally along the cylindrical reception area.

5. The apparatus according to claim 1 wherein the first and second members define an opening on one side into which the animal is inserted and a back stop member on the opposite side having a contact surface against which the animal rests as at least one of the first and second members is moved in a direction generally parallel to the contact surface to the second closed position.

6. The apparatus according to claim 5 wherein the back stop member is a piece of at least one of the first and second members

7. The apparatus according to claim 6 wherein the back stop member is a separate element over which at least one of the first and second members can move.

8. The apparatus according to claim 1 wherein the engagement members have a length greater than 2 inches.

9. The apparatus according to claim 1 wherein the engagement members are mounted on a frame which is arranged such that it can be mounted on a cart or on a fence of a pen as required.

10. The apparatus according to claim 1 including a cart mounted on wheels for movement from pen to pen within an animal containment area, the cart having a bin with an open top and depending walls for containing a number of the animals, the first and a second animal engagement members being mounted on the cart for receiving the animals extracted from the bin.

11. The apparatus according to claim 10 wherein the cart has a rack and/or a standing rod for a plurality of tools to be used on the animal when restrained.

12. An animal restraint apparatus for use in treatment procedures on the animal when restrained comprising:
a first and a second animal engagement member;
the first and second members being mounted for relative movement from a first separated position in which the animal can be inserted between inwardly facing surfaces of the first and second members to a second closed position in which the animal is restrained between the inwardly facing surfaces of the first and second members;
the first and second members each having a length to extend along a significant part of the body of the animal;
the members having at least the inwardly facing surfaces formed of a resilient compressible material such that the surfaces can deform under pressure from the animal during squeezing the animal in the second closed position;
the first and second members being arranged to define an opening on one side into which the animal is inserted;
and a back stop member on the opposite side from the opening having a contact surface against which the animal engages when inserted in the opening;
the contact surface being arranged to locate the animal while at least one of the first and second members is moved in a direction generally across the contact surface to the second closed position.

13. The apparatus according to claim 12 wherein the first and second members and the backstop member are each formed of a cushion material mounted on a rigid support.

14. The apparatus according to claim 12 wherein the back stop member is a piece of at least one of the first and second members.

15. The apparatus according to claim 12 wherein the back stop member is a separate element over which at least one of the first and second members can move.

16. The apparatus according to claim 12 wherein the engagement members have a length greater than 2 inches.

17. The apparatus according to claim 1 wherein the engagement members are mounted on a frame which is arranged such that it can be mounted on a cart or on a fence of a pen as required.

18. The apparatus according to claim 12 including a cart mounted on wheels for movement from pen to pen within an animal containment area, the cart having a bin with an open top and depending walls for containing a number of the animals, the first and a second animal engagement members being mounted on the cart for receiving the animals extracted from the bin.

19. The apparatus according to claim 18 wherein the cart has a rack and/or a standing rod for a plurality of tools to be used on the animal when restrained.

20. An animal restraint apparatus for use in treatment procedures on the animal when restrained comprising:
a cart mounted on wheels for movement from pen to pen within an animal containment area;
the cart having a bin with an open top and depending walls for containing a number of the animals,
a first and a second animal engagement member mounted for relative movement from a first separated position in which the animal can be inserted between inwardly facing surfaces of the first and second members to a second closed position in which the animal is restrained between the inwardly facing surfaces of the first and second members;
the first and a second animal engagement members being mounted on the cart for receiving the animals extracted from the bin.

21. The apparatus according to claim 20 wherein the cart has a rack and/or a standing rod for a plurality of tools to be used on the animal when restrained.

22. The apparatus according to claim 21 wherein the cart has electrical power outlet or battery power outlet for supplying power to one or more of the plurality of tools to be used on the animal when restrained.
